(19) United States
(12) Patent Application Publication
(10) Pub. No.: US 2015/0339178 A1
(43) Pub. Date: Nov. 26, 2015

(54) PROCESSING SYSTEM AND METHOD OF OPERATING A PROCESSING SYSTEM

(71) Applicants: DIRK HEISSWOLF, MUNICH (DE); THOMAS HEINRICH MEYER, MUNICH (DE); ANDREAS RALPH PACHL, NEUBIBERG (DE)

(72) Inventors: DIRK HEISSWOLF, MUNICH (DE); THOMAS HEINRICH MEYER, MUNICH (DE); ANDREAS RALPH PACHL, NEUBIBERG (DE)

(73) Assignee: FREESCALE SEMICONDUCTOR, INC., Austin, TX (US)

(21) Appl. No.: 14/283,320

(22) Filed: May 21, 2014

(51) Int. Cl. G06F 11/07

(52) U.S. Cl. CPC G06F 11/0757

(57) ABSTRACT

A processing device, comprising one or more functional units and a hardware-serviced watchdog timer connected to the functional units is described. The functional units are capable of generating service events which are hardware events of said one or more functional units. The functional units are arranged to generate the signals in response to an application executed on the processing device and making use of the functionality thereof. The watchdog timer is arranged to start a new timeout period in response to any one of said signals. The service events may include, for example, a start or an end of a data transfer operation to or from one of the functional units.

A method of operating a processing device is described as well.

### FIELD OF THE INVENTION

This invention relates to a processing device and to a method of operating a processing device.

### BACKGROUND OF THE INVENTION

A computing system may comprise a means for detecting malfunction of the computing system autonomously. Auto diagnosis tools can be particularly desirable in safety applications. Techniques for detecting malfunction generally require some amount of redundancy to the system's resources. This redundancy usually has a price, as it may involve additional hardware or reduce the performance of the system. As trade-offs must be made between the detectability of potential faults and the additional system cost, a broad spectrum of safety features, capable of detecting a system failure, have been proposed in the past.

Software-triggered watchdog timers are a common safety feature in microcontroller products. A software triggered watchdog timer can be arranged to report an error condition if it is not serviced by a certain code sequence within a defined timeout window. Service sequences, which are replicas of the code sequence for servicing the watchdog timer, may have to be provided at various positions in the application code. This can be done manually by a programmer, by inserting the code sequence at the desired positions inside the application code. Missing service sequences can cause false timeouts. Falsely placed service sequences, on the other hand, may service the watchdog even if a processor executing the application code is stuck in an unintended loop, for example.

### SUMMARY OF THE INVENTION

The present invention provides a processing device and a method of operating a processing device as described in the accompanying claims.

Specific embodiments of the invention are set forth in the dependent claims.

These and other aspects of the invention will be apparent from and elucidated with reference to the embodiments described hereinafter.

### BRIEF DESCRIPTION OF THE DRAWINGS

Further details, aspects and embodiments of the invention will be described, by way of example only, with reference to the drawings. Elements in the figures are illustrated for simplicity and clarity and have not necessarily been drawn to scale.

FIG. 1 schematically shows a flowchart of an example of a method of operating a watchdog timer in a system-on-chip.

FIG. 2 schematically shows an example of an embodiment of a processing device that may be used to implement an example of the present invention.

FIG. 3 illustrates a block diagram of a processing device that may be used to implement an example of the present invention.

FIG. 4 illustrates a block diagram of a system on chip (SoC) device that may be used to implement an example of the present invention.

### DETAILED DESCRIPTION OF THE PREFERRED EMBODIMENTS

In contrast to software-triggered watchdog timers, which may require a careful adaptation of program code in order to monitor application specific time-out periods, the technique described below provides a safety feature capable of monitoring a generic system property without any software interaction. The technique is based on the insight that a running system, i.e. a system which is not idle, must eventually produce some output. This output may, for example, be a transmission over a communication interface, a toggling of output pins, or an access of data in a memory unit. Delayed output or lack of output may be considered as an indication of a faulty behavior of the system. Unexpected or faulty system output may be observable and detected by receiving components of the system.

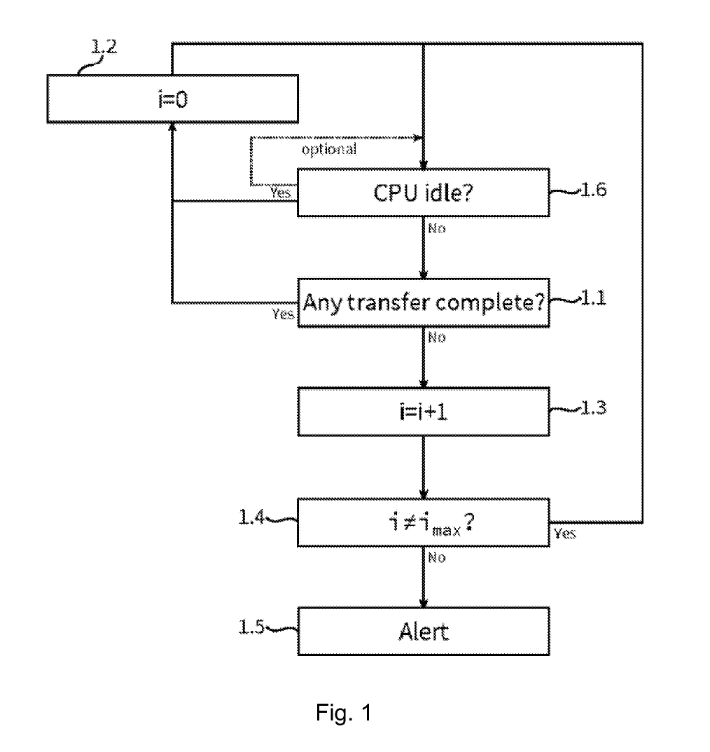

An example of a mode of operation of a watchdog timer in a processing device, such as a system-on-chip (SoC), is described with reference to FIG. 1. The watchdog timer may be arranged to monitor one or more hardware components of the system-on-chip for the occurrence of service events. The hardware components are referred to as functional units in the following. A service event is a condition or a status, which is determined by the hardware component generating the service event. Signals relating to such service events may be generated in response to an application executed on the processing device 10 and making use of the functionality thereof. Such signal relating to a service event is a hardware event of said functional unit. The functional units comprise, e.g., a communication interface, general purpose output (GPO) logic, or a memory controller, notably in systems which perform data logging operations. Service events occurring in response to the hardware components are associated with data transactions operable by the hardware components. Whenever data is transmitted over a communication interface or GPO logic, for example between the interface/logic and an device external to the system-on-chip, or when data is written to or read from a memory unit connected to the memory controller, e.g., for logging purposes, a service event may be generated and reported to the watchdog timer. The reception of a service event may prompt the watchdog timer to restart its time-out period, e.g., by resetting a clock cycle counter. The clock cycle counter of the watchdog timer may be increased regularly.

When the system is not idle, e.g., when it is not in a low power mode (box 1.6), the watchdog timer may be arranged to check repeatedly, e.g., periodically, e.g., at every clock cycle, whether a service event has occurred (box 1.1). The idle state may be determined at system level, e.g., by a processing unit of the system. The watchdog timer may be arranged to maintain a timer count i. When a service event has occurred, the watchdog timer may reset the timer count i back to an initial value, e.g., to zero (box 1.2). Upon receiving of a signal relating to the service event by the watchdog timer from one of the functional units a new timeout period is started in response to said received signal relating to said service event. If, however, no service event has occurred, the watchdog timer may increment the timer count by one increment, e.g., by one (box 1.3). The watchdog timer may thus increment the timer count by one increment in each cycle, e.g., in each clock cycle, unless it has detected a service event. The watchdog timer may then check whether the timer count is less than a predefined time-out value iₘₐₓ (box 1.4). The maximum timer count iₘₐₓ, i.e. the length of the timeout period, may be configurable, e.g., to suit application specific requirements. For instance, the length of the timeout period may be set in dependence of an application identifier which identifies an application arranged to be run on the SoC. If the timer count i is lower than or at least differs from the maximum timer count iₘₐₓ, the watchdog timer may take no further action and the process flow may return to box 1.6 and a new cycle may start. If, however, the timer count has reached or exceeds the maximum timer count iₘₐₓ (box 1.4), the watchdog timer may initiate an alert action (box 1.5). The alert action may comprise, for example, asserting an alert flag or triggering a machine exception, e.g. by asserting an interrupt signal indicative of an exception. In one example, detection of the idle state (in box 1.6) leads to a reset of the timeout period (box 1.2). In another example, detection of the idle state (in box 1.6) prevents the timeout count from advancing; this is represented in FIG. 1 by the loop marked as optional from box 1.6 back to the same box 1.6.

The set of service events, that is, the set of hardware events which will reset the watchdog timer, may include, for example, the following types of events: completion of a transaction operated by a communication interface, e.g., completion of data transfers between communication integrated peripherals (IPs) of the system-on-chip and one or more devices external to the system-on-chip; programming of non-volatile memory (NVM); toggling of outputs, e.g., toggling of GPO of the system-on-chip; and read and/or write access to memory via a memory controller of the system-on-chip. The service events may notably comprise a subset of the set of events that are used to trigger interrupts. In this case, observation logic for detecting hardware events may be shared among the watchdog timer and a hardware interrupt controller.

The timeout period of the watchdog timer, i.e., the maximum timer count iₘₐₓ, may be configured, for example, in an application-specific manner once at the beginning of the execution of an application. Starting the application in question may thus include setting the timeout period to a certain value in dependence of the application in question. This operation, i.e., configuring the timeout period, may be carried out by the application software itself or by transferring an application-specific timeout parameter from, e.g., non-volatile memory, to the watchdog timer. The set of service events may be configured as well, e.g., along with the timeout period.

The watchdog timer may be arranged to be not controllable by any application on the SoC. The watchdog timer may thus be robust against programming errors. More specifically, when the timeout period has been configured and the watchdog timer is active, the application software on the SoC may have no control over the watchdog timer. Any service event will service the watchdog, i.e., reset the timer count and initiate a new timeout period. The watchdog timer may comprise separate counters for different types of service events.

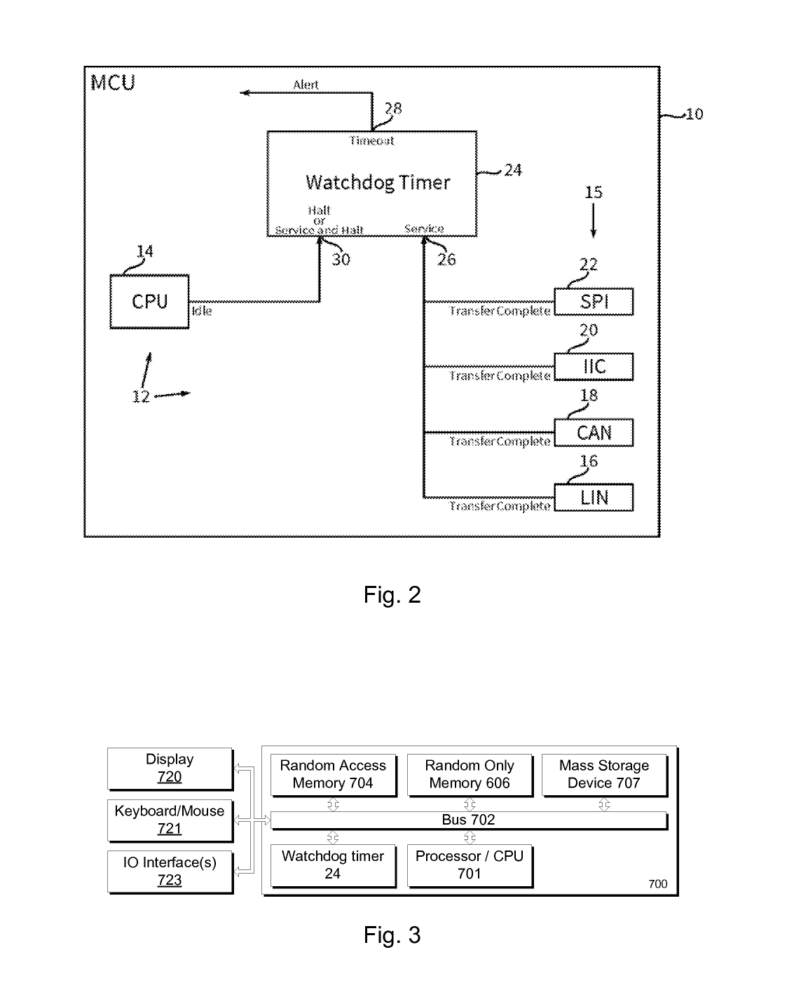

FIG. 2 schematically shows a simplified example of an embodiment of a system-on-chip (SoC) 10. The SoC 10 may, for example, be a microcontroller unit (MCU). The SoC 10 may comprise one or more functional units 12. The functional units 12 may include, for example, a processing unit 14 and one or more interface units 15 connected to the processing unit 14. The processing unit 14 may be arranged to execute program instructions provided in, e.g., a program memory unit (not shown) of the SoC 10. The one or more interface units 15 may be arranged to enable the SoC 10 to communicate with external devices. In the example, the interface units 15 comprise a Local Interconnect Network (LIN) unit 16, a Controller Area Network (CAN) unit 18, an Inter-Integrated Circuit (IIC) unit 20 and a Serial Peripheral Interface (SPI) unit 22. Instead of or in addition to the functional units 14, 16, 18, 20, 22, the SoC 10 may comprise other functional units (not shown). The one or more functional units 12 of the SoC 10 may be capable of generating signals, which relate to service events which are hardware events of the one or more functional units 12.

The SoC 10 may further comprise a watchdog timer 24. The watchdog timer 24 may be connected to the one or more functional units 12 and arranged to start a new timeout period in response to any signal relating to a service event. Starting a new timeout period may comprise resetting the timer count i in the watchdog timer 24 to an initial value, e.g., resetting it to zero.

A service event may, for example, inform about a start or an end of a data transfer operation from one of the functional units 15. The event signals may include a signal indicative of at least one of a start and an end of a data transfer operation performed by one of the functional units 12. One example of a signal relating to a service event may be a signal from any one of the interface units 15 that a transaction involving the respective interface unit has been completed. A transaction may, for example, be a read or write operation involving one or more memory elements of the respective interface unit.

The watchdog timer 24 may be applicable to monitor proper operation of an application run on the SoC 10. The execution of the application on the SoC 10 involves the use of one or more functional units 12. Service events are generated in response to the interoperation of an application executed on the SoC and the functional units 12. This means each of the functional units 12 is arranged to generate one or more service events in the hardware thereof when an application executed on the SoC makes use of its functionality. The proper operation of the executed application involves a number of service events occurring within a predefined period of time. Accordingly, the timeout period of the watchdog timer 24 may be configured to a maximum period of time expected between service events for instance from one of the functional units 12. A timeout period of the watchdog timer 24 may be configurable individually and separately for the service events of each functional unit 12.

In particular, the execution of the application on the processing unit 14 of the SoC 10 may involve the data transactions via at least one of the interface units 15 with one or more external devices. In response to the service events signals indicative of the data transactions as described above are generated. The proper operation of the executed application involves a number of service events occurring in response to data transactions within a predetermined period of time. Accordingly, the timeout period of the watchdog timer 24 may be configurable with respect to an expected maximum period of time between service events. A timeout period of the watchdog timer 24 may be configurable individually and separately for the service events of each interface unit 15.

The signals relating to the service event may further include an idel signal from one of the functional units 12. The SoC, or the processing unit as a component of the SoC, may have an idle mode and the watchdog timer may be arranged to halt when the SoC, or the processing unit, is in the idle mode. Unnecessary alerts may thus be avoided. The same effect may be achieved, without halting the watchdog timer, by feeding an idle signal as a service event to the watchdog timer 24 when the SoC (or the processing unit) is in an idle mode. As the main purpose of this hardware service watchdog timer is to provide a generic check for system responsiveness, the idle state may be considered as waiting for an input event which is expected to trigger a system response.

In the example, an idle signal 30 generated by the processing unit 14 causes the watchdog timer 24 to either halt or to reset the timeout period before halting. The idle signal may indicate that the processing unit 14, or the entire set of functional units 12, are not expected to perform any communication or data processing operations.

In one example, the watchdog timer 24 may comprise an input 26 connected to the one or more functional units 12. The watchdog timer 24 may thus be enabled to detect service events generated by the functional units 12. Signals relating to the service events are provided via the input 26 to the watchdog timer 24. The watchdog timer 24 may further comprise an output 28 for providing, for example, an alert flag. As explained above, the alert flag may be a signal asserted when the current timeout period of the watchdog timer 24 has expired, i.e., when the watchdog timer 24 has not observed any service event before expiry of the timeout period.

The alert flag signal asserted by the watchdog timer may be indicative of which of a set of counters has reached or exceeded the maximum time count configured for the respective counter thereof. Each counter of the set of counters may be served by a specific functional unit or a specific type of service event.

The watchdog timer 24, which is a hardware-serviced watchdog timer, may be added relatively easily to existing designs of systems-on-chip because its design may be independent of the software that may be run by the processing unit 14, for example. The watchdog timer 24 may not require any software interaction. Therefore, it may be possible to include it easily as a supplemental safety feature in a system-on-chip. Furthermore, the watchdog timer 24 may be immune against programming errors. Also, it may be available even at early stages of the software development concerning the SoC in question.

From the above description, it is understood that the term hardware-serviced relates to the origin of the signals inputted to the watchdog timer for resetting the one or more counters thereof. The signals inputted to the watchdog timer are signals relating to service events, which are generated in hardware of the functional units. In other words, the functional units comprise hardware circuits, which provide the signals relating to service events. Such a hardware circuit may be detector circuit generating a signal in response to a condition or state of the functional unit or a signal available in the functional unit may be tapped and supplied to the watchdog timer.

In addition to the hardware-serviced watchdog timer 24, the SoC 10 may comprise a software-serviced watchdog timer (not shown), which may be integrated in the processing unit 14, for example. The software-serviced watchdog timer may be arranged to be serviced by watchdog service requests encoded in one or more applications operated on the SoC and generated by them. In other words, the watchdog timer 24 may be supplemented with a software-serviced watchdog timer, thus combining the advantages of both types of watchdog timers.

FIG. 3 illustrates a block diagram of a processing device with a watchdog timer that may be used to implement an example of the present invention. The processing device 700 includes a processor 702 coupled through a bus 701 to a random access memory (RAM) 704, a read only memory (ROM) 706, and a mass storage device 707. Mass storage device 707 represents a persistent data storage device, such as one or more fixed disk drive(s). The mass storage device 707 may be coupled via any data communication connection to the processing device. Processor 702 may be embodied in a general-purpose processor, an application processing device, a special purpose processor, or a specifically programmed logic device. One or more IO devices may be coupled via the bus 701 to the processing device 700. The IO devices may comprise inter alia a display device 720 coupled to the processor 702 through the bus 701 and provides graphical output for the processing device 700, a keyboard and/or cursor control unit 721 coupled to the bus 701 for communicating information and command selections to processor 602 and one or more further input/output (I/O) interfaces 723 also coupled to the processor 702 through the bus 701 and used to control and transfer data to peripheral electronic devices (printers, other computers, etc.) connected to processing device 700. It should be noted that the architecture of FIG. 6 is provided only for purposes of illustration, and that a processing device used in conjunction with the present invention is not limited to this specific architecture.

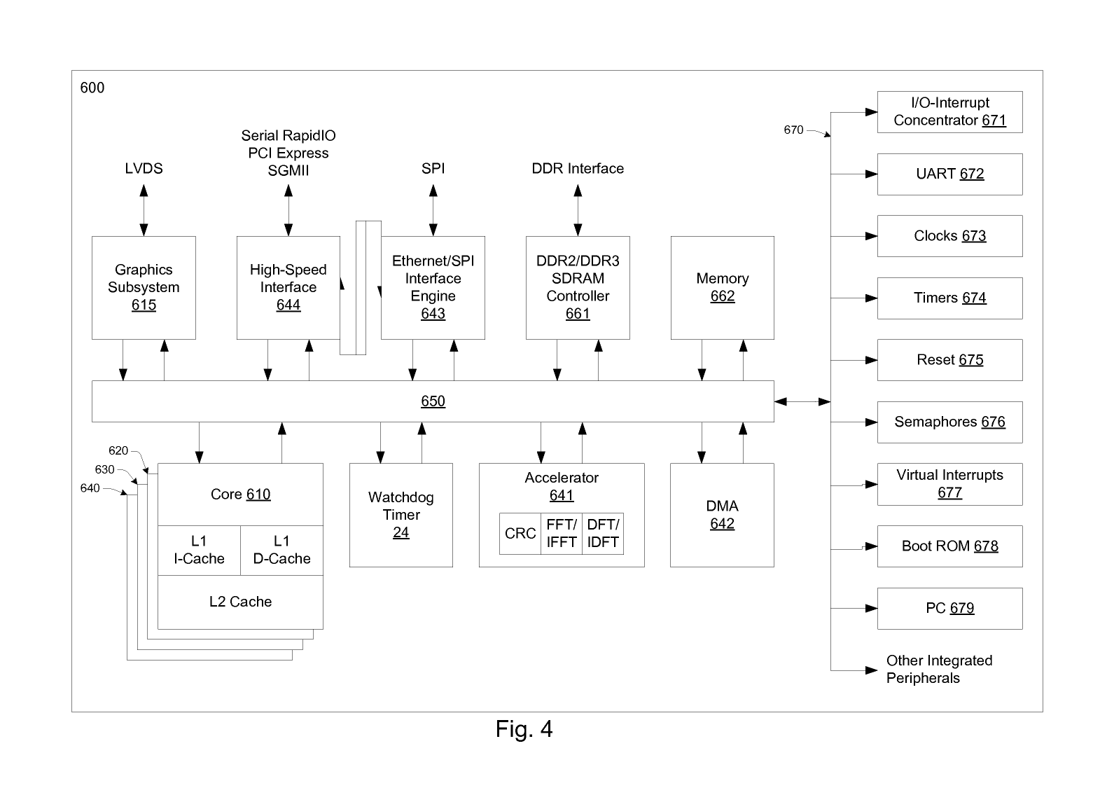

Referring now to FIG. 4, there is shown a simplified schematic diagram of a multi-core system on chip 600 with a watchdog timer and multiple processor cores 610, 620, 630, 640 that may be used to implement an example of the present invention. As illustrated, each of the processor cores 610, 620, 630, 640 is coupled to one or more levels of cache memory, such as an L1 instruction cache (I-Cache), L1 data cache (D-Cache), and/or L2 cache. While the processor cores 610, 620, 630, 640 may be identically designed or homogenous, the multi-core SoC may also include one or more cores having a different design. For example, the depicted multi-core SoC 600 also includes an accelerator 641 which may include one or more processor cores for supporting hardware acceleration for DFT/iDFT and FFT/iFFT algorithms and for CRC processing. Each processor core is coupled across an interconnect bus 650 to one or more memory controllers 661, which are coupled in turn to one or more banks of system memory (not shown). The interconnect bus 250 also couples the processor cores to a Direct Memory Access (DMA) controller 642, network interface 643, a high speed serial interface 644, and to other hardware-implemented integrated peripherals 671 to 679. The interconnect bus 650 may be a coherency fabric.

Each of the processor cores 610, 620, 630, 640 may be configured to execute instructions and to process data according to a particular instruction set architecture (ISA), such as x86, PowerPC, SPARC, MIPS, and ARM, for example. Those of ordinary skill in the art also understand the present invention is not limited to any particular manufacturer's microprocessor design. The processor core may be found in many forms including, for example, any 32-bit or 64-bit microprocessor manufactured by Freescale, Motorola, Intel, AMD, Sun or IBM. However, any other suitable single or multiple microprocessors, microcontrollers, or microcomputers may be utilized. In the illustrated embodiment, each of the processor cores 610, 620, 630, 640 may be configured to operate independently of the others, such that all cores may execute in parallel. In some embodiments, each of cores may be configured to execute multiple threads concurrently, where a given thread may include a set of instructions that may execute independently of instructions from another thread. Such a core may also be referred to as a multithreaded (MT) core. Thus, a single multi-core SoC 600 with four cores will be capable of executing a multiple of four threads in this configuration. However, it should be appreciated that the invention is not limited to four processor cores and that more or fewer cores can be included. In addition, the term “core” refers to any combination of hardware, software, and firmware typically configured to provide a processing functionality with respect to information obtained from or provided to associated circuitry and/or modules (e.g., one or more peripherals, as described below). Such cores include, for example, digital signal processors (DSPs), central processing units (CPUs), microprocessors, and the like. These cores are often also referred to as masters, in that they often act as a bus master with respect to any associated peripherals. Furthermore, the term multi-core (or multi-master) refers to any combination of hardware, software, and firmware that that includes two or more such cores (e.g., cores 610 and 620), regardless of whether the individual cores are fabricated monolithically (i.e., on the same chip) or separately. Thus, a second core may be the same physical core as first core, but has multiple modes of operation (i.e., a core may be virtualized).

As depicted, each processor core (e.g., 610) may include a first level (L1) cache which includes a data cache (D-Cache) and an instruction cache (I-Cache). In addition, a second level of cache memory (L2) may also be provided at each core, though the L2 cache memory can also be an external L2 cache memory which is shared by one or more processor cores. The processor core 610 executes instructions and processes data under control of the operating system (OS) which may designate or select the processor core 610 as the control or master node for controlling the workload distribution amongst the processor cores 610, 620, 630, 640. Communication between the cores 610, 620, 630, 640 may be over the interconnect bus 650 or over a crossbar switch and appropriate dual point to point links according to, for example, a split-transaction bus protocol such as the HyperTransport (HT) protocol (not shown).

The processor cores 610, 620, 630, 640 and accelerator 641 are in communication with the interconnect bus 650 which manages data flow between the cores and the memory. The interconnect bus 650 may be configured to concurrently accommodate a large number of independent accesses that are processed on each clock cycle, and enables communication data requests from the processor cores 610, 620, 630, 640 to external system memory and/or an on-chip memory 662, as well as data responses therefrom. In selected embodiments, the interconnect bus 650 may include logic (such as multiplexers or a switch fabric, for example) that allows any core to access any bank of memory, and that conversely allows data to be returned from any memory bank to any core. The interconnect bus 650 may also include logic to queue data requests and/or responses, such that requests and responses may not block other activity while waiting for service. Additionally, the interconnect bus 650 may be configured as a chip-level arbitration and switching system (CLASS) to arbitrate conflicts that may occur when multiple cores attempt to access a memory or vice versa.

The interconnect bus 650 is in communication with main memory controller 661 to provide access to the memory 662 or main memory (not shown). Memory controller 661 may be configured to manage the transfer of data between the multi-core SoC 600 and system memory, for example. In some embodiments, multiple instances of memory controller 661 may be implemented, with each instance configured to control a respective bank of system memory. Memory controller 661 may be configured to interface to any suitable type of system memory, such as Double Data Rate or Double Data Rate 2 or Double Data Rate 3 Synchronous Dynamic Random Access Memory (DDR/DDR2/DDR3 SDRAM), or Rambus DRAM (RDRAM), for example. In some embodiments, memory controller 661 may be configured to support interfacing to multiple different types of system memory. In addition, the Direct Memory Access (DMA) controller 642 may be provided which controls the direct data transfers to and from system memory via memory controller 661.

The multi-core SoC 600 may comprise a dedicated graphics sub-system 615. The graphics sub-system 615 may be configured to manage the transfer of data between the multi-core SoC 600 and graphics sub-system 615, for example, through the interconnect bus 250. The graphics sub-system 615 may include one or more processor cores for supporting hardware accelerated graphics generation. The graphics generated by the graphics sub-system 615 may be outputted to one or more displays via any display interface such as LVDS, HDMI, DVI and the like.

As will be appreciated, the multi-core SoC 600 may be configured to receive data from sources other than system memory. To this end, a network interface engine 643 may be configured to provide a central interface for handling Ethernet and SPI interfaces, thus off-loading the tasks from the cores. In addition, a high speed serial interface 644 may be configured to support one or more serial RapidIO ports, a PCI-Express Controller, and/or a serial Gigabit Media Independent Interface (SGMII). In addition, one or more interfaces 670 may be provided which are configured to couple the cores to external boot and/or service devices, such as I/O interrupt concentrators 671, UART device(s) 672, clock(s) 673, timer(s) 674, reset 675, hardware semaphore(s) 676, virtual interrupt(s) 677, Boot ROM 678, 12C interface 679, GPIO ports, and/or other modules.

In the foregoing specification, the invention has been described with reference to specific examples of embodiments of the invention. In particular, the above description has exemplified the invention of the present application with regard to a system-on-chip (SoC), which should be understood merely as an illustrative, non-limiting example of a processing device. It will, however, be evident that various modifications and changes may be made therein without departing from the broader spirit and scope of the invention as set forth in the appended claims.

The connections as discussed herein may be any type of connection suitable to transfer signals from or to the respective nodes, units or devices, for example via intermediate devices. Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

Each signal described herein may be designed as positive or negative logic. In the case of a negative logic signal, the signal is active low where the logically true state corresponds to a logic level zero. In the case of a positive logic signal, the signal is active high where the logically true state corresponds to a logic level one. Note that any of the signals described herein can be designed as either negative or positive logic signals. Therefore, in alternate embodiments, those signals described as positive logic signals may be implemented as negative logic signals, and those signals described as negative logic signals may be implemented as positive logic signals.

The terms “assert” or “set” and “negate” (or “deassert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures can be implemented which achieve the same functionality. For example, the watchdog timer 24 may comprise a hardware event detection unit (not shown) arranged separately from the counter that provides the timer count i.

Any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments. For example, an operation of detecting or identifying a service event may be carried out explicitly, e.g., by raising a detection flag, and the watchdog timer may respond to the detection signal thus generated, or the watchdog timer may respond immediately to the service event, without explicitly detecting service event.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as computer systems.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

1. A processing device, which comprises:
one or more functional units capable of generating signals relating to service events which are hardware events of said one or more functional units,
wherein the one or more functional units are arranged to generate the signals relating to service events in response to an application executed on the processing device and making use of the functionality thereof; and
a watchdog timer connected to said one or more functional units and arranged to start a new timeout period in response to any one of said signals relating to said service events.

2. The processing device of claim 1, wherein a length of the timeout period is configurable.

3. The processing device of claim 2, arranged to set the length of the timeout period in dependence of an application identifier which identifies the application arranged to be run on the processing device.

4. The processing device of claim 1, wherein said one or more functional units comprise one or more interface units, which are arranged for data communication with one or more external devices.

5. The processing device of claim 4, wherein the signals relating to the service events include a signal indicative of at least one of a start and an end of a data transfer operation performed by one of the functional units.

6. The processing device of claim 1, wherein the signals relating to the service events include an idle signal from one of the functional units.

7. The processing device of claim 1, wherein the processing device has an idle mode and the watchdog timer is arranged to halt when the processing device is in the idle mode.

8. The processing device of claim 1, comprising a processing unit for executing program instructions.

9. The processing device of claim 1, wherein the watchdog timer is arranged to assert an alert flag in response to a timeout.

10. The processing device of claim 8, wherein the watchdog timer is arranged to de-assert the alert flag in response any signal relating to one of the service events.

11. The processing device of claim 1, wherein the watchdog timer is not controllable by any application on the processing device.

12. The processing device of claim 1, further comprising a software-serviced watchdog timer or other safety features.

13. The processing device of claim 11, wherein the software-serviced watchdog timer is arranged to be serviced by watchdog service requests encoded in one or more applications on the processing device.

14. A method of operating a processing device, which comprises a functional unit and a watchdog timer connected to said functional unit, wherein said method comprises:
said functional unit, generating a signal relating to a service event, which is a hardware event of said functional unit, in response to an application executed on the processing device and making use of the functionality thereof; and
said watchdog timer, receiving the signal relating to the service event and starting a new timeout period in response to said received signal relating to said service event.
